(19) United States
(12) Patent Application Publication
(10) Pub. No.: US 2015/0321463 A1
(43) Pub. Date: Nov. 12, 2015

(54) FLEXIBLE PLATEN COVER AND A HEAT PRESS HAVING A FLEXIBLE PLATEN COVER

(71) Applicant: GroupeSTAHL, St. Clair Shores, MI (US)

(72) Inventor: Benjamin Robinson, Carmichaels, PA (US)

(21) Appl. No.: 14/707,517

(22) Filed: May 8, 2015

Related U.S. Application Data
(60) Provisional application No. 61/991,137, filed on May 9, 2014.

(51) Int. Cl. B41F 1/38

(52) U.S. Cl. CPC B41F 1/38

(57) ABSTRACT

The present teachings provide for a cover for a platen of a heat press. The cover can include a cover body, a first fastener member and a second fastener member. The cover body can be formed of a flexible material. The first fastener member can be affixed to a first edge of the cover body and can be adapted to removably couple the first edge of the cover body to the platen of the heat press. The second fastener member can be affixed to a second edge of the flexible material that is opposite the first edge. The second fastener member can be adapted to removably couple the second edge of the flexible material to the platen of the heat press.

### CROSS-REFERENCE TO RELATED APPLICATIONS

This application claims the benefit of U.S. Provisional Application 61/991,137, FILED ON May 9, 2014. The entire disclosure of the above application is incorporated herein by reference.

### FIELD

The present disclosure relates to a flexible platen cover and a heat press having a flexible platen cover.

### BACKGROUND

This section provides background information related to the present disclosure which is not necessarily prior art.

Heat presses for heat and pressure printing and transfer applications typically include a lower platen and an upper platen that is generally above the lower platen and configured to press down on the lower platen. Typically, a work piece (e.g. fabric or garment) and a heat-activated article (e.g. letters, logos, images, graphics) are positioned on the lower platen while the upper platen is separated from the lower platen. Once the work piece and article are properly positioned, the upper platen is moved vertically down over the lower platen to sandwich the work piece and article between the upper and lower platens. One or both of the platens typically contains a heating element and the platens are configured to apply a preset amount of heat and pressure to the work piece and article for a predetermined amount of time (i.e. cure time). After the cure time is completed, the upper platen is lifted up so that the operator can remove the finished product.

Typically the upper and lower platens have smooth, hard surfaces (e.g. Polytetrafluoroethylene “PTFE”) that sandwich the work piece and the heat-activated article between the upper and lower platens. In some applications, this sandwiching can cause marring, bruising, or scorching of the work piece or heat-activated article. Delicate materials (e.g. polyesters and performance wear) can be especially susceptible to these issues. Additionally, the smooth surfaces can cause the finished product to have a smooth or glossy finish, when a more matte finish may be desired. The smooth surfaces can also permit the work piece and heat-activated article to move relative to each other, which can cause misalignments of the finished product.

Prior attempts to mitigate some of these issues included placing loose cover sheets over portions of the work piece and the heat-activated article before closing the heat press. Such loose cover sheets are susceptible to moving or becoming misaligned with the work piece and heat-activated article, which can result in similar issues (e.g. marring, bruising, scorching, heat lines). Furthermore, loose cover sheets must be removed and re-aligned with each application process. Additionally, loose cover sheets can be susceptible to picking up dirt or contamination from a surrounding work space.

### SUMMARY

This section provides a general summary of the disclosure, and is not a comprehensive disclosure of its full scope or all of its features.

The present teachings provide for a cover for a platen of a heat press. The cover can include a cover body, a first fastener member and a second fastener member. The cover body can be formed of a flexible material. The first fastener member can be affixed to a first edge of the cover body and can be adapted to removably couple the first edge of the cover body to the platen of the heat press. The second fastener member can be affixed to a second edge of the flexible material that is opposite the first edge. The second fastener member can be adapted to removably couple the second edge of the flexible material to the platen of the heat press.

The present teachings further provide for a heat press including a first platen, a second platen, a heating element, an arm, and a platen cover. The first platen can include a first surface, first fastener member and a second fastener member. The second platen can include a second surface that can be configured to oppose the first surface. The heating element can be configured to heat the first platen. The arm can be configured to move the first platen relative to the second platen between an open position wherein the first surface is spaced apart from the second surface a first distance, and a closed position wherein the first surface is spaced apart from the second surface a second distance that is less than the first distance. The platen cover can include a cover body, a third fastener member, and a fourth fastener member. The third fastener member can be configured to couple the cover body to the first fastener member. The fourth fastener member can be configured to couple the cover body to the second fastener member. The cover body can be formed of a flexible material and can be configured to be disposed between the first and second surfaces when the first fastener member is coupled to the third fastener member and the second fastener member is coupled to the fourth fastener member.

The present teachings further provide for a method of operating a heat press. The method can include affixing a first end of a cover to a first platen proximate to a first side of the first platen. The method can include positioning a portion of the cover between the first platen and a second platen. The method can include affixing a second end of the cover to the first platen proximate to a second side of the first platen that is opposite the first side.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a heat press in accordance with the present disclosure;

FIG. 2 is another perspective view of the heat press of FIG. 1;

FIG. 3 is a perspective view of a flexible platen cover in accordance with the present teachings; and

FIG. 4 is a perspective view of the flexible platen cover of FIG. 3 mounted to the heat press of FIG. 1.

Corresponding reference numerals indicate corresponding parts throughout the several views of the drawings.

### DETAILED DESCRIPTION

Example embodiments will now be described more fully with reference to the accompanying drawings.

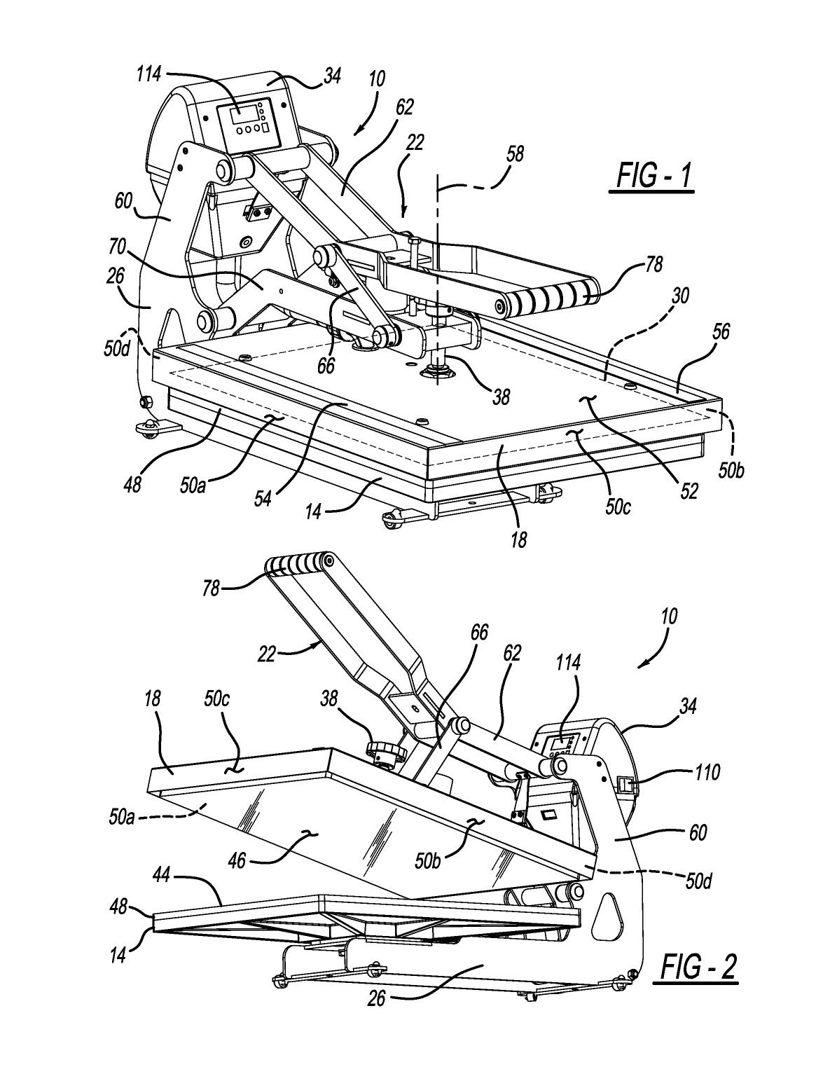

With reference to FIGS. 1-4, a heat press 10 and a platen cover 12 are illustrated in accordance with the present teachings. With specific reference to FIGS. 1 and 2, the heat press 10 is illustrated in a closed position (FIG. 1) and an open position (FIG. 2) without the platen cover 12 mounted to the heat press 10. In general, the heat press 10 can include a lower platen 14, an upper platen 18, an arm mechanism 22, a base frame 26, a heating element 30, and a control mechanism 34. In the example provided, the heat press 10 can also include an adjustment mechanism 38.

The lower platen 14 can be mounted to the base frame 26. The lower platen 14 can have a generally rectangular shape, though other configurations can be used. The lower platen 14 can have an upper face 44. The upper face 44 can have a smooth, non-stick surface (e.g. Polytetrafluoroethylene “PTFE”). In the example provided, lower platen 14 includes an insulating pad 48 and the upper face 44 is defined by the insulating pad 48. The insulating pad 48 can be a cushioned, resilient pad that can cover a relatively harder upper surface (not specifically shown) of the lower platen 14. The insulating pad 48 can be affixed to or can be removably mounted to the relatively harder upper surface (not specifically shown) of the lower platen 14. The insulating pad 48 can be formed of a generally insulating material (e.g. fiberglass). The upper face 44 of the insulating pad 48 can be coated in a non-stick coating (e.g. PTFE).

The upper platen can be supported by the arm mechanism 22 generally above the lower platen 14. The upper platen 18 can have a generally rectangular shape, though other configurations can be used. The upper platen 18 can have a lower face 46 configured to oppose the upper face 44 of the lower platen 14, a plurality of sides 50a, 50b, 50c, 50d, and an upper face 52 that is opposite the lower face 46. Additionally, the lower platen 14 and/or the upper platen 18 can include platen pads, such as the insulating pad 48 (shown mounted to the lower platen 14), for accommodating surface irregularities occurring on work pieces (not shown) to be inserted between the upper and lower platens 18, 14, such as fabric and a heat applied transfer for example. The upper platen 18 can also include at least one first fastener member 54 and at least one second fastener member 56.

In the example provided, the first and second fastener members 54, 56 are each part of a hook-and-loop fastening system (e.g. Velcro®), though other types of fasteners can be used (e.g. snaps, adhesive). The first fastener member 54 can be fixedly mounted to the upper platen 18 proximate to a first one of the sides 50a and the second fastener member 56 can be fixedly mounted to the upper platen 18 proximate to a second one of the sides 50b that can be opposite the first one of the sides 50a. In the example provided, the first and second fastener members 54, 56 are fixedly mounted to the upper face 44 of the upper platen 18 proximate to the respective first or second ones of the sides 50a, 50b. In the example provided, the first and second ones of the sides 50a, 50b are longitudinal sides of the upper platen 18 and the first and second fastener members 54, 56 extend substantially the length of the first and second ones of the sides 50a, 50b, though other configurations can be used. In the example provided, the first and second fastener members 54, 56 are fixedly mounted to the upper plate 18 by a high temperature adhesive (not specifically shown), though other configurations can be used.

In an alternative construction, not specifically shown, the first and second fastener members 54, 56 can be fixedly mounted to the upper face 52 proximate to sides 50c and 50d instead of sides 50a and 50b. In an alternative construction, not specifically shown, the first and second fastener members 54, 56 can be fixedly mounted directly to the sides 50a and 50b, or to 50c and 50d, instead of being mounted to upper face 52.

The arm mechanism 22 can be configured to move the upper platen 18 relative to the lower platen 14 generally toward and away from the lower platen 14. The arm mechanism 22 can be configured to move the upper platen 18 between the closed position (FIG. 1) and the open position (FIG. 2). In the open position, the upper platen 18 can be spaced apart from the lower platen 14 to permit the work pieces (not shown) to be positioned between the upper and lower platens 18, 14. In the closed position, the work pieces (not shown) can be pressed between the lower and upper faces 44, 46. As the upper platen 18 approaches the closed position, the arm mechanism 22 can be configured to move the upper platen 18 generally along a first axis 58 that can be perpendicular to the lower platen 14.

In the example provided, the arm mechanism 22 can be a four bar linkage with an over center toggle mechanism to position and latch the heat press 10 in the closed position, though any suitable mechanism for raising and lowering the upper platen 18 can be used, such as a pneumatic cylinder for example. In the example provided, the arm mechanism 22 can include a first link 60, a second link 62, a third link 66, and a fourth link 70. The first link 60 can be fixed to the base frame 26 and can be integrally formed therewith. The first and second links 60, 62 can be pivotably coupled to each other. The second link 62 can define a handle 78 that can be used by an operator of the heat press 10 to move the arm mechanism 22 between the open and closed positions.

The second and third links 62, 66 can be pivotably coupled at a location along the second link 62 that can be between the first link 60 and the handle 78. The third and fourth links 66, 70 can be pivotably coupled at a location that is spaced apart from the first link 60. The fourth link 70 can be pivotably coupled to the first link 60 at a location that is spaced apart from the second and third links 62, 66. The fourth link 70 can generally support the upper platen 18 for movement with the fourth link 70. The first, second, third, and fourth links 60, 62, 66, 70 can have lengths such that when the upper platen 18 is in the closed position, the arm mechanism 22 can be in a toggle, or locked position. In the toggle position, the second and third links 62, 66 can generally align to lock the arm mechanism 22 and the upper platen 18 in the closed position.

The adjustment mechanism 38 can be configured to control the spacing between the lower platen 14 and the upper platen 18 in the closed position. The upper platen 18 can be mounted to the adjustment mechanism 38. The adjustment mechanism 38 can be threadably coupled to the fourth link 70 such that rotation of the adjustment mechanism 38 can cause the upper platen 18 to move along the first axis 58 relative to the fourth link 70. Thus, tightening the adjustment mechanism 38 can increase the pressure that is applied between the upper and lower platens 18, 14 when the upper platen 18 is in the closed position.

In the example provided, the heating element 30 is disposed within the upper platen 18. Alternatively or additionally, the heating element 30 can be disposed within the lower platen 14. The heating element 30 can be any suitable type of heating device, such as conventional resistive heating elements and the like, which may be disposed within the upper platen 18 and can follow a serpentine or other pattern to span throughout the surface area of the upper platen 18. The heating element 30 can be coupled to a typical power supply (not shown) via the control mechanism 34.

The control mechanism 34 can include a thermocouple (not shown), a switch 110, and a display 114. The switch 110 can be configured to selectively provide power from the power source (not shown) to the heating element 30. The thermocouple (not shown) can be disposed within either of the upper or lower platens 18, 14 and can be configured to measure the temperature of the upper and/or lower platens 18, 14. The control mechanism 34 can be configured to control the temperature of the heating element 30, such as by controlling the electrical power supplied to the heating element 30. The display 114 can be configured to display information useful to the operator, such as temperature and time of operation for example. In the example provided, the display 114 is a digital display, though other configurations can be used.

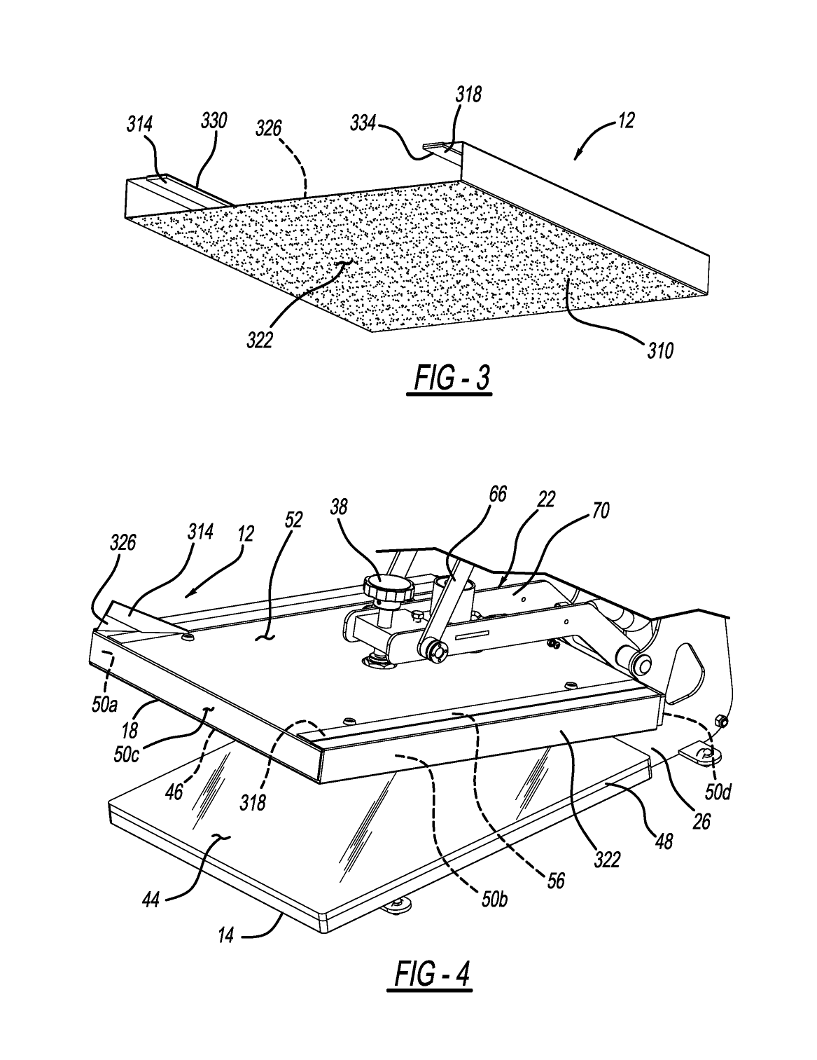

With reference to FIG. 3, the platen cover 12 is illustrated separately from the heat press 10. In FIG. 4, the platen cover 12 is illustrated mounted to the heat press 10. The platen cover 12 can include a cover body 310, at least one third fastener member 314, and at least one fourth fastener member 318. The cover body 310 can be a flexible material. The cover body 310 can have an outer surface 322 and an inner surface 326. The outer surface 322 can have a surface texture and can be configured to grip a work piece and/or a heat-activated article. The cover body 310 can be a material that is configured to permit heat to be transferred from the upper platen 18, through the cover body 310, to the work piece and heat activated article. The cover body 310 can be a resilient material that can stretch when pulled and return to a natural length when released. In the example provided, the cover body 310 is a virgin silicone rubber material that is approximately 0.032 inches thick, though other types of materials or thicknesses can be used.

The third fastener member 314 is complementary to the first fastener member 54 and the fourth fastener member 318 is complementary to the second fastener member 56 such that the first and second fastener members 54, 56 are configured to be removably coupled to the third and fourth fastener members 314, 318, respectively. In the example provided, the third and fourth fastener members 314, 318 are each a part of the hook-and-loop fastening system (e.g. Velcro®) that is complementary to the first and second fastener members 54, 56, though other types of fasteners can be used (e.g. snaps, adhesive).

The third fastener member 314 can be fixedly coupled to the inner surface 326 of the cover body 310 along a first edge 330 of the cover body 310. The fourth fastener member 318 can be fixedly coupled to the inner surface 326 of the cover body 310 along a second edge 334 of the cover body 310 that can be opposite the first edge 330.

With additional reference to FIG. 4, the platen cover 12 can be removably mounted to the upper platen 18 to cover the lower face 46 of the upper platen 18. To mount the platen cover 12, an operator can attach either of the third or fourth fastener members 314, 318 to one of the first or second fastener members 54, 56. The operator can then stretch the cover body 310 around the corresponding side 50a, 50b, 50c, or 50d, the lower face 46, and then around the opposite side 50a, 50b, 50c, or 50d to attach the other of the third or fourth fastener members 314, 318 to the other of the first or second fastener members 54, 56.

When mounted to the upper platen 18, the cover body 310 can span across substantially the entire lower face 46 of the upper platen 18 and can be stretched in tension across the lower face 46. In other words, the cover body 310 can have a natural length between the third and fourth fastener members 314, 318 that is less than the distance from the first fastener member 54, around the upper platen 18, across the lower face 46, and to the second fastener member 56.

In operation, when the platen cover 12 is mounted to the upper platen 18 to cover the lower face 46, the cover body 310 can remain in contact with the heated lower face 46 when the upper platen 18 is in the open position. By remaining in contact with the lower face 46 while the upper platen 18 is in the open position, the heat loss from the cover body 310 between subsequent transfer applications can be minimized. Thus, the cover body 310 can remain a more constant temperature during subsequent transfer applications when compared to the use of separate cover sheets (not shown) that can be generally placed between the upper platen 18 and the work piece and the heat-activated article.

It has been found that this heat retention within the platen cover 12 can have the unexpected result of reducing cycle time and improving overall productivity. Furthermore, the consistency of temperature can reduce marring of the work piece, heat press lines, bruises, and scorching of the work piece, especially with polyester and other delicate work pieces.

It has also been found that the combination of one platen (e.g. lower platen 14) having a relatively low friction surface (e.g. PTFE) and the opposite platen (e.g. upper platen 18) being covered with a flexible, relatively high friction surface (e.g. textured silicone rubber) has the unexpected result of gripping the heat-activated article against the work piece, while permitting the heat-activated article and work piece to move together with the cover body 310 throughout the heat transfer application. The textured surface of the cover body 310 can act as a thousand miniature pressure points to evenly distribute the pressure and allow the work piece and heat-activated article to move as one unit. Unlike typical cover sheets (not shown), the platen cover 12 can stretch and move with the heat-activated article and the work piece without concern of the cover sheet becoming misaligned or failing to cover part of the work piece.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A cover for a platen of a heat press, the cover comprising:
a cover body formed of a flexible material;
a first fastener member affixed to a first edge of the cover body and adapted to removably couple the first edge of the cover body to the platen of the heat press; and
a second fastener member affixed to a second edge of the flexible material that is opposite the first edge, the second fastener member being adapted to removably couple the second edge of the flexible material to the platen of the heat press.

2. The cover of claim 1, wherein the flexible material is silicone rubber.

3. The cover of claim 1, wherein the cover body has a textured surface that is configured to face away from the platen when the first and second fastener members are coupled to the platen.

4. The cover of claim 1, wherein the flexible material is a resilient material that is configured to be stretched to a length that is greater than a natural length of the cover body when the first and second fastener members are coupled to the platen.

5. The cover of claim 1, wherein the first and second fastener members are a part of a hook-and-loop fastener system.

6. The heat press of claim 1, wherein the cover body has a thickness of approximately 0.032 inches.

7. A heat press comprising:
a first platen including a first surface, first fastener member and a second fastener member;
a second platen including a second surface configured to oppose the first surface;
a heating element configured to heat the first platen;
an arm configured to move the first platen relative to the second platen between an open position wherein the first surface is spaced apart from the second surface a first distance, and a closed position wherein the first surface is spaced apart from the second surface a second distance that is less than the first distance; and
a platen cover including a cover body, a third fastener member, and a fourth fastener member, the third fastener member being configured to couple the cover body to the first fastener member, the fourth fastener member being configured to couple the cover body to the second fastener member, the cover body being formed of a flexible material and configured to be disposed between the first and second surfaces when the first fastener member is coupled to the third fastener member and the second fastener member is coupled to the fourth fastener member.

8. The heat press of claim 7, wherein the flexible material is silicone rubber.

9. The heat press of claim 7, wherein the cover body has a textured third surface that is configured to oppose the second surface when the first fastener member is coupled to the third fastener member and the second fastener member is coupled to the fourth fastener member.

10. The heat press of claim 7, wherein the flexible material is a resilient material that is configured to be stretched to a length that is greater than a natural length of the cover body when the first fastener member is coupled to the third fastener member and the second fastener member is coupled to the fourth fastener member.

11. The heat press of claim 7, wherein the first, second, third, and fourth fastener members are hook-and-loop fasteners.

12. The heat press of claim 7, wherein the cover body has a third surface that opposes the second surface when the first fastener member is coupled to the third fastener member and the second fastener member is coupled to the fourth fastener member, wherein the third surface has a coefficient of friction that is greater than the second surface.

13. The heat press of claim 7, wherein the first and second fasteners are disposed on a fourth surface of the first platen that is opposite and spaced apart from the first surface.

14. The heat press of claim 7, wherein the cover body has a thickness of approximately 0.032 inches.

15. The heat press of claim 7, wherein the first platen is an upper platen and the second platen is a lower platen.

16. The heat press of claim 7, further comprising a base, the arm coupling the first platen to the base for movement relative to the base between the open and closed positions, the second platen being fixedly coupled to the base.

17. The first heat press of claim 7, wherein the first fastener member is configured to be releasably coupled to the third fastener member and the second fastener member is configured to be releasably coupled to the fourth fastener member.

18. A method of operating a heat press, the method comprising:
affixing a first end of a cover to a first platen proximate to a first side of the first platen;
positioning a portion of the cover between the first platen and a second platen; and
affixing a second end of the cover to the first platen proximate to a second side of the first platen that is opposite the first side.

19. The method of claim 18, further comprising:
stretching the cover greater than a natural length of the cover; and
affixing the second end of the cover to the first platen proximate to the second side of the first platen while the cover is stretched.

20. The method of claim 19, further comprising:
inserting a work piece and a heat-activated article between the first and second platens;
heating the first platen; and
compressing the work piece and heat-activated article between the first and second platens.
